(19) United States
(12) Patent Application Publication
(10) Pub. No.: US 2014/0345383 A1
(43) Pub. Date: Nov. 27, 2014

(54) DEVICE AND METHOD FOR TESTING THE QUALITY OF A DISPLAY SUBSTRATE

(71) Applicant: SHENZHEN CHINA STAR OPTOELECTRONICS TECHNOLOGY CO., LTD., Shenzhen, Guangdong (CN)

(72) Inventors: Liang Li, Shenzhen (CN); Boyang Ren, Shenzhen (CN)

(21) Appl. No.: 14/123,226

(22) PCT Filed: Jun. 28, 2013
(86) PCT No.: PCT/CN2013/078346

§ 371 Date: Dec. 2, 2013

(30) Foreign Application Priority Data
May 22, 2013 (CN) 201310193478.6

(51) Int. Cl. G01N 29/04

(52) U.S. Cl. CPC G01N 29/041
USPC 73/595

(57) ABSTRACT

A method and device for testing the quality of a display substrate are provided to detect whether the substrate has been broken. The device comprises an ultrasonic emitter and an ultrasonic receiver, both of which are set on the side opposite to the processing area, and it further comprises an ultrasonic analyzer connected to the ultrasonic receiver. The ultrasonic emitter emits ultrasonic waves for testing to the substrate, the ultrasonic receiver receives the ultrasonic waves reflected from the substrate, and the ultrasonic analyzer connected to the ultrasonic receive analyzes the received ultrasonic waves to determine whether the substrate has been broken. In the present invention, the fragment on anywhere comprising the processing area and the non-processing area of the substrate can be detected, the broken substrate can be picked out overall, and thus preventing the broken substrate from damaging the production line and the products.

### FIELD OF THE INVENTION

The present invention relates to the field of manufacturing technology for substrate, and more particularly to a device and method for testing the quality of a display substrate.

### BACKGROUND OF THE INVENTION

During the manufacturing process for the substrates such as TFT-LCDs, the test for the manufacturing quality of the substrate is demanded to find out whether there is fragment in the substrate. In traditional manufacturing technology, the fragment is sought mainly through a photoelectric testing method or a pictorial testing method.

In the photoelectric testing method, a light emitting device can emit light to the substrate to be tested, and then a light sensor can receive the light reflected from the substrate, whether the substrate has been broken can be determined by testing the change of the intensity of the reflected light. However, this kind of testing method will be influenced by the manufacturing process of the substrate. Since the processing area on the substrate can't receive the reflected light well, it can't be determined whether the processing area has been broken.

In the pictorial testing method, the substrate is shined by a backlight, and then the real-time images of the substrate can be received by a CCD lens, so whether there is fragment can be determined by comparing the grey level of the real-time images and that of the normal substrate image. Since the above comparison can't be implemented in the processing area, it also can't be determined whether the processing area has been broken in this testing method.

The processing area on the substrate can't be tested through each testing method in the prior art. Thus the reliability of the testing is low and the broken substrates can't be found out entirely.

### SUMMARY OF THE INVENTION

The object of the present invention is to provide a method and device for testing the quality of a display substrate, aiming at the drawbacks that the broken substrates can't be found out entirely since the processing area on the substrate can't be tested effectively by the method for testing the substrate in the prior art.

The technical schemes to solve the above technical problems are as follows. A device for testing the quality of a display substrate is provided, which is used to test the quality of the substrate in the display, the substrate comprises a front surface and a back surface opposite to the front surface, the front surface is provided with a processing area for the semiconductor array, and a non-processing area is provided around the process area, the device for testing the quality of the display substrate comprises an ultrasonic emitter and an ultrasonic receiver, the ultrasonic emitter and the ultrasonic receiver are set on the back surface of the substrate; the ultrasonic emitter emits ultrasonic waves to the back surface of the substrate, and the ultrasonic waves are used to test the quality of the substrate; the ultrasonic receiver receives the ultrasonic waves reflected from the substrate; the device for testing the quality of the display substrate further comprises an ultrasonic analyzer connected to the ultrasonic receiver, and the ultrasonic analyzer is used to analyze the received ultrasonic waves to determine whether the substrate has been broken.

In the device for testing the quality of a display substrate according to the present invention, the emitting angle of the ultrasonic emitter is equal to the receiving angle of the ultrasonic receiver.

In the device for testing the quality of a display substrate according to the present invention, the device for testing the quality of a display substrate further comprises an emitter positioning device, the ultrasonic emitter is mounted on the emitter positioning device, and the emitter positioning device can drive the ultrasonic emitter to rotate or move translationally.

In the device for testing the quality of a display substrate according to the present invention, the device for testing the quality of a display substrate further comprises an receiver positioning device, the ultrasonic receiver is mounted on the receiver positioning device, the receiver positioning device can drive the ultrasonic receiver to rotate or move translationally, and the ultrasonic emitter can emit the ultrasonic waves to the back surface of the substrate at a preset emitting angle.

In the device for testing the quality of a display substrate according to the present invention, it further comprises a production line to drive the substrate to move horizontally, a number of ultrasonic receivers are arranged in a line in the direction perpendicular to the moving direction of the substrate driven by the production line, and the length of the line that the number of ultrasonic receivers arranged in is matched with the width of the substrate.

A method for testing the quality of a display substrate is also provided, it comprises following steps:

defining a processing area and a non-processing area on the front surface of the substrate, installing an ultrasonic emitter and an ultrasonic receiver on the back surface of the substrate, the ultrasonic emitter emits ultrasonic waves to the back surface of the substrate and the ultrasonic waves are used to test the quality of the substrate;

the ultrasonic receiver receiving the ultrasonic waves reflected from the substrate;

an ultrasonic analyzer connected to the ultrasonic receiver analyzing the received ultrasonic waves to determine whether the substrate has been broken.

In the method for testing the quality of a display substrate according to the present invention, it further comprises the following step:

setting the emitting angle of the ultrasonic emitter equal to the receiving angle of the ultrasonic receiver.

In the method for testing the quality of a display substrate according to the present invention, it further comprises the following step:

installing the ultrasonic emitter on an emitter positioning device that can drive the ultrasonic emitter to rotate to a preset emitting angle or to move translationally to a preset emitting location, and then the ultrasonic emitter emitting the ultrasonic waves to the back surface of the substrate at the preset emitting angle.

In the method for testing the quality of a display substrate according to the present invention, it further comprises the following step:

installing the ultrasonic receiver on a receiver positioning device that can drive the ultrasonic receiver to rotate or move translationally.

In the method for testing the quality of a display substrate according to the present invention, it further comprises the following steps:

driving the substrate to move horizontally by a production line;

arranging a number of ultrasonic receivers in a line in the direction perpendicular to the moving direction of the substrate driven by the production line, so as to receive the ultrasonic waves, and the length of the line that the number of ultrasonic receivers arranged in is matched with the width of the substrate.

When implementing the present invention, the fragment on anywhere of the substrate can be found out, and the broken substrate can be picked out overall, and thus preventing the broken substrate from damaging the production line and the products. Besides that, it can provide clues and basis for seeking the reasons of the fragments, so as to facilitate the maintenance and repair for the production line.

### BRIEF DESCRIPTION OF THE DRAWINGS

The present invention will be further described with reference to the accompanying drawings, in the accompanying drawings:

FIG. 1 is a top view of the substrate being tested according to the present invention.

FIG. 2 is a side view of the substrate being tested according to the present invention.

FIG. 3 is a structural diagram for a device for testing the quality of a display substrate according to the present invention.

FIG. 4 is a structural diagram for an ultrasonic emitter.

FIG. 5 is a structural diagram for an ultrasonic receiver.

FIG. 6 is a structural diagram for an ultrasonic receiver arranged in a single line.

### DETAILED DESCRIPTION OF THE PREFERRED EMBODIMENT

The present invention may be further described in the following in detail with reference to the accompanying drawings and embodiments.

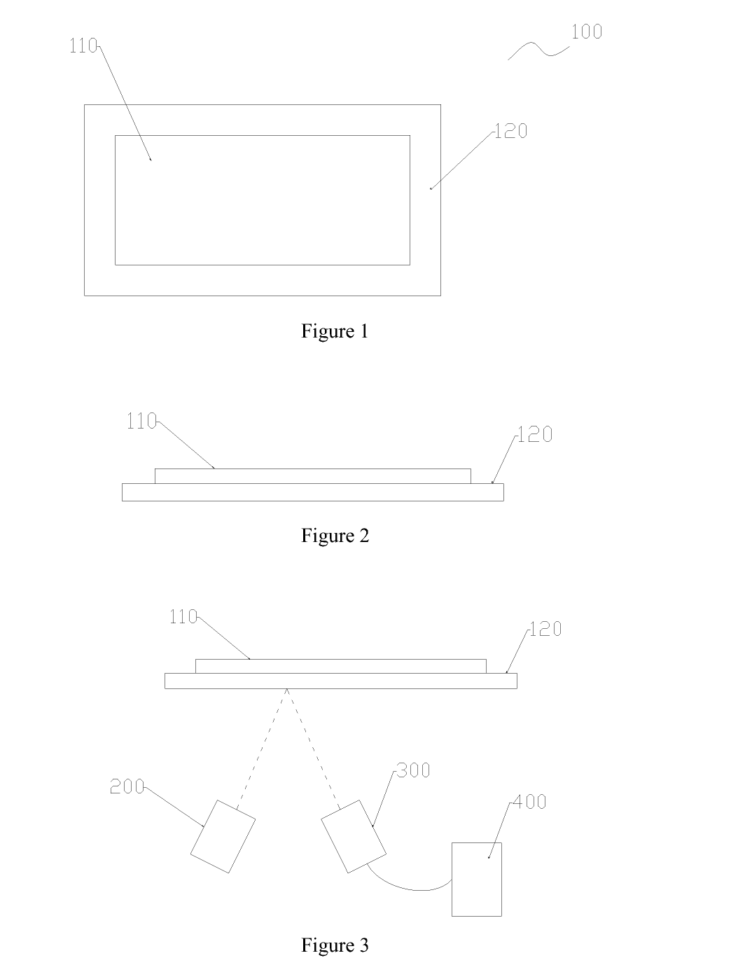

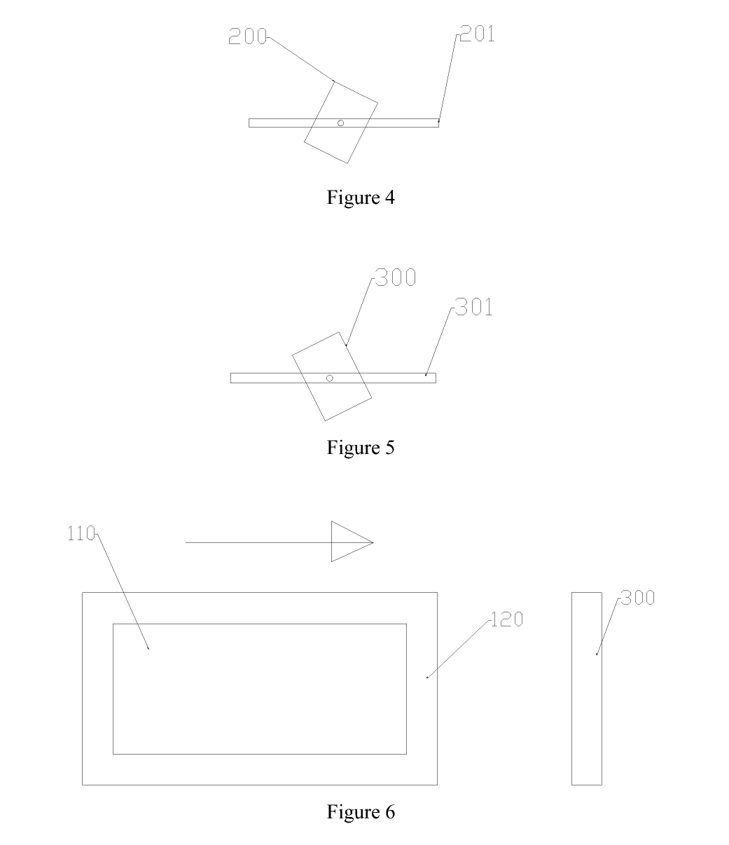

The substrate 100, such as the glass substrate used in the TFT-LCD, shown in FIGS. 1 and 2 is tested in the present invention. The front surface of the substrate 100 comprises a processing area 110 and a non-processing area 120. The processing area 110 is an area in which a semiconductor array is set. The non-processing area 120 is a area without printed circuit patterns. The non-processing area 120 is set around the processing area 110. Since the processing area 110 has a semiconductor array, the optical methods for testing the substrate can not be implemented on the processing area 110 effectively, for example, the photoelectric testing method and the pictorial testing method can not be implemented effectively.

However, in a common display substrate, the front surface is provided with a processing area 110 and a non-processing area 120, and the back surface that is opposite to the front surface dose not need to be provided with circuits, so the back surface is always smooth and flat. The ultrasonic waves can always be reflected with good directionality by a smooth and flat plane. As a result, in the present invention, the fragments in the substrate are tested thoroughly through the directionality of the ultrasonic waves, based on the smoothness of the back surface of the substrate 100. FIG. 3 shows the detailed testing device.

On the back surface of the substrate, an ultrasonic emitter 200 and an ultrasonic receiver 300 are provided. The ultrasonic emitter 200 emits the ultrasonic waves to the back surface of the substrate 100, in a way of being tilted with respect to the plane of the substrate. Then the ultrasonic waves are reflected by the substrate 100 and received by the ultrasonic receiver 300 sequentially. The ultrasonic receiver 300 transforms the received ultrasonic waves into electronic signals and delivers the electronic signals to an ultrasonic analyzer 400 which is connected to the ultrasonic receiver 300, so as to analyze and compare the electronic signals. In case that the substrate has been broken, the reflecting status of the ultrasonic waves at the broken spot will be different from its reflecting status at the normal smooth area. As a result, the ultrasonic analyzer 400 may detect a sudden spike wave and the broken condition of the substrate 100 can be found out.

Since the ultrasonic waves has mirror-reflecting characteristic on the smooth and flat surface, the incident angle of the ultrasonic emitter 200 is defined equal to the receiving angle of the ultrasonic receiver 300. Thus, the quality of the display substrate can be presented accurately. In the present invention, the incident angle of the ultrasonic emitter 200 refers to the angle between the emitting direction of the ultrasonic emitter 200 and the normal direction of the plane that the display substrate resides in. The receiving angle of the ultrasonic receiver 300 refers to the angle between the receiving direction of the ultrasonic receiver 300 and the normal direction of the plane that the display substrate resides in.

In order to position the broken spot, the ultrasonic emitter 200 and the ultrasonic receiver 300 are mounted on positioning devices. The ultrasonic emitter 200 is mounted on a emitter positioning device 201. The ultrasonic emitter 200 can rotate round the emitter positioning device 201, so that it can emit ultrasonic waves with different angles to the substrate 100. On the other hand, the ultrasonic receiver 300 is mounted on a receiver positioning device 301. The ultrasonic receiver 300 can rotate round the receiver positioning device 301, and it can move translationally along the receiver positioning device 301 as well. When the ultrasonic emitter 200 emits ultrasonic waves at different angles to the substrate 100, the ultrasonic receiver 300 can move translationally to the corresponding position and rotate to a suitable receiving angle to receive the ultrasonic waves. Based on the locations of the two positioning devices 201/301, the ultrasonically testing range on the substrate 100 can be determined, and further, the location of the broken spot on the substrate 100 can be determined.

The ultrasonic emitter 200 and the ultrasonic receiver 300 can carry out the test with a constant angle. In this case, the ultrasonic emitter 200 and the ultrasonic receiver 300 move translationally and cooperatively. Based on the specific locations that the ultrasonic emitter 200 and the ultrasonic receiver 300 has moved to, the ultrasonically testing range on the substrate 100 can be determined, and further, the location of the broken spot on the substrate 100 can be determined.

In another embodiment of the present invention, the ultrasonic receiver 300 is a single-line-arranged ultrasonic receiver. Namely, a number of receiver probes are arranged in a row, and they receive the emitted ultrasonic waves simultaneously. The substrate 100 moves along the direction of the arrow in FIG. 6 on the production line. The ultrasonic receiver 300 is a single-line-arranged ultrasonic receiver that is matched with the width of the substrate 100 (namely perpendicular to the moving direction of the substrate). When the substrate is moving, the ultrasonic receiver 300 can detect the damage condition over the width of the substrate 100 at a time. The efficiency of the testing is high.

Above are detailed embodiments of the present invention, which can not be used to limit the scope of the present invention. It will be understood by one skilled in the art that equivalents may be substituted in the light of the present invention without departing from the scope of the present invention, and those various changes known by one skilled in the art shall fall into the protection of the invention.

1. A device for testing the quality of a display substrate, used to test the quality of the substrate in the display, the substrate comprises a front surface and a back surface opposite to the front surface, the front surface is provided with a processing area for the semiconductor array, and a non-processing area is provided around the process area, wherein, the device for testing the quality of the display substrate comprises an ultrasonic emitter and an ultrasonic receiver, the ultrasonic emitter and the ultrasonic receiver are set on the back surface of the substrate; the ultrasonic emitter emits ultrasonic waves to the back surface of the substrate, and the ultrasonic waves are used to test the quality of the substrate; the ultrasonic receiver receives the ultrasonic waves reflected from the substrate; the device for testing the quality of the display substrate further comprises an ultrasonic analyzer connected to the ultrasonic receiver, and the ultrasonic analyzer is used to analyze the received ultrasonic waves to determine whether the substrate has been broken.

2. The device for testing the quality of a display substrate according to claim 1, wherein the emitting angle of the ultrasonic emitter is equal to the receiving angle of the ultrasonic receiver.

3. The device for testing the quality of a display substrate according to claim 1, wherein the device for testing the quality of a display substrate further comprises an emitter positioning device, the ultrasonic emitter is mounted on the emitter positioning device, and the emitter positioning device can drive the ultrasonic emitter to rotate or move translationally.

4. The device for testing the quality of a display substrate according to claim 3, wherein the device for testing the quality of a display substrate further comprises an receiver positioning device, the ultrasonic receiver is mounted on the receiver positioning device, the receiver positioning device can drive the ultrasonic receiver to rotate or move translationally, and the ultrasonic emitter can emit the ultrasonic waves to the back surface of the substrate at a preset emitting angle.

5. The device for testing the quality of a display substrate according to claim 1, wherein it further comprises a production line to drive the substrate to move horizontally, a number of ultrasonic receivers are arranged in a line in the direction perpendicular to the moving direction of the substrate driven by the production line, and the length of the line that the number of ultrasonic receivers arranged in is matched with the width of the substrate.

6. A method for testing the quality of a display substrate, wherein it comprises following steps:
defining a processing area for the semiconductor array and a non-processing area on the front surface of the substrate, the non-processing area is set around the processing area, installing an ultrasonic emitter and an ultrasonic receiver on the back surface of the substrate, the ultrasonic emitter emits ultrasonic waves to the back surface of the substrate and the ultrasonic waves are used to test the quality of the substrate;
the ultrasonic receiver receiving the ultrasonic waves reflected from the substrate;
an ultrasonic analyzer connected to the ultrasonic receiver analyzing the received ultrasonic waves to determine whether the substrate has been broken.

7. The method for testing the quality of a display substrate according to claim 6, wherein it further comprises the following step:
setting the emitting angle of the ultrasonic emitter equal to the receiving angle of the ultrasonic receiver.

8. The method for testing the quality of a display substrate according to claim 6, wherein it further comprises the following step:
installing the ultrasonic emitter on an emitter positioning device that can drive the ultrasonic emitter to rotate to a preset emitting angle or to move translationally to a preset emitting location, and then the ultrasonic emitter emitting the ultrasonic waves to the back surface of the substrate at the preset emitting angle.

9. The method for testing the quality of a display substrate according to claim 8, wherein it further comprises the following step:
installing the ultrasonic receiver on a receiver positioning device that can drive the ultrasonic receiver to rotate or move translationally.

10. The method for testing the quality of a display substrate according to claim 6, wherein it further comprises the following steps:
driving the substrate to move horizontally by a production line;
arranging a number of ultrasonic receivers in a line in the direction perpendicular to the moving direction of the substrate driven by the production line, so as to receive the ultrasonic waves, and the length of the line that the number of ultrasonic receivers arranged in is matched with the width of the substrate.
